(19) United States
(12) Patent Application Publication
(10) Pub. No.: US 2010/0239622 A1
(43) Pub. Date: Sep. 23, 2010

(54) DETERGENT PRINTED FILM

(75) Inventors: Samuel ICHT, Ramat-Hasharon (IL); Sharon Maayan, Mochav Tzafririm (IL)

Correspondence Address: Fleit Gibbons Gutman Bongini & Bianco PL, 21355 EAST DIXIE HIGHWAY, SUITE 115, MIAMI, FL, 33180, US

(73) Assignee: PHOTO PRINT SOAP LTD., Ramat Hasharon (IL)

(21) Appl. No.: 12/789,794

(22) Filed: May 28, 2010

Related U.S. Application Data
(62) Division of application No. 12/088,188, filed on Mar. 26, 2008.

(30) Foreign Application Priority Data
Sep. 26, 2005 (IL) 171091

(51) Int. Cl. A61K 8/02; A61Q 19/10; A61Q 11/00; A61Q 5/02; C11D 17/00; C11D 3/22

(52) U.S. Cl. 424/401; 510/142; 510/120; 424/49; 510/276; 510/224; 510/441; 510/214; 510/109; 510/356

(57) ABSTRACT

The present invention discloses a water-soluble detergent printed film comprising a film support and at least one print, being printed thereon and/or therein said film, said film is a water-soluble detergent adapted for effective cleansing of various human body and goods cleaning. The present invention also discloses a method of producing a water-soluble detergent printed film, comprising forming a detergent film; and, printing the same with at least one print.

### FIELD OF THE INVENTION

The present invention generally relates to a water-soluble detergent printed film and to a method producing the same.

### BACKGROUND OF THE INVENTION

Detergents are generally packaged in various bulky forms such as powders, soap bars, solutions, sprays, hence require voluminous space marketplace. Use of bulky detergents is associated with inventorying, shipping, shelving and ultimately disposing of the containers in which these detergents are provided. Moreover, various expensive and coarse means for dispensing detergent were suggested in the art, providing for the application of an effective, exact and uniform detergent dose. Those dispensing means are not mechanically stable, tend to accumulate germs and contaminate the detergent with dirt and pathogens.

Opulence of commercially available inventory of detergents in their ever changing packages and compositions guide detergents' producers to present a fresh and appealing look to their products. Commercialization of the products, by advertisement and well targeted commercials is highly important in differentiating one product from another.

Various detergent films were presented in the literature, Hence, U.S. Pat. No. 6,730,648 to Colgate Palmolive Co. discloses a unit dose detergent film formed from a water soluble polymer and a cleaning solution, comprises up to 12% of a water soluble cellulosic polymer and up to 50% of at least one. German patent 19,949,980 to Henkel teaches a detergent portions packaged in a water-soluble polymeric film, are protected against premature water ingress by internal pressure built up by an internal anhydrous gas or gas-releasing substance.

The art therefore does not teach a means for providing an equable detergent dose, and a commercializable detergent film, nor printing on detergent films. It is the object of the present invention to overcome the aforementioned disadvantages.

### SUMMARY OF THE INVENTION

It is therefore one object of the present invention to present a water-soluble detergent printed film comprising a film support and at least one print, being printed thereon and/or therein said film, said film is a water-soluble detergent adapted for an effective, exact and uniform detergent dose for cleansing of various humane body and goods cleaning.

It is according to another embodiment of the present invention wherein the film is used for oral care.

It is according to one embodiment of the present invention wherein the film support is at least partially made of water soluble polymers, such as polysaccharides and their derivatives, proteins and synthetic polymers or a mixture thereof.

It is according to another embodiment of the present invention wherein the polysaccharides are selected from oligosaccharide, polysaccharide, glycosaminoglycans, polyuronides, guar gum, gum Karaya, gum acacia, British gum, agar, gum Arabic starch, carib gum, carrageenin and xanthan or a mixture thereof.

It is according to another embodiment of the present invention wherein the polyuronides are selected from pectins and algins, and the natural galactomannan film-forming materials, such as locust bean gum and guar gum. The polyuronides may be present as magnesium or calcium alginates or pectates or a mixture thereof.

It is according to another embodiment of the present invention wherein the polysaccharides film composition additionally comprising secondary film-forming agents. The secondary film-forming agents are preferably selected from polysaccharides, polymers, pulps, pectin, fibers, yarns, cellulose glycolic acid and derivatives thereon or any combination thereof.

It is according to another embodiment of the present invention wherein the polysaccharides film composition additionally comprising additives, selected from plasticizers, filers, biocides, preservatives, elastomers, medicaments, vitamins, enzymes, nutrichemicals, buffers, coloring agents, perfume agents, surface active agents (foaming agents), emulsifiers, co-emulsifiers, stabilizers, pigments such as titanium oxide, liquid detergents, salts, plasticizers flavors or flavorants, cross-linking agents, nutrients, aromatic substances, fibers, yarns, silica, plant extracts, fruits or vegetables and whole parts of milled particles thereof, humectants, bleaching agents or any combination thereof.

It is according to another embodiment of the present invention wherein the film is at least partially water-soluble characterized by a requisite tensile strength and elasticity.

It is according to another embodiment of the present invention wherein the film is shaped in a manner selected from a leaf-like member, a plane (e.g., 2D shaped) sheet, wave-shaped or otherwise 3D shaped member, slit to tape and used as a wrapper or any combination thereof.

It is according to another embodiment of the present invention wherein the film is at least partially water-immiscible, and may disassembled in a predetermined environment

It is according to another embodiment of the present invention wherein the dimensions of the film are 0.2 to about 2.5 mm thick; and from about 0.5*0.5 cm or less to about 50*50 cm or more in length and height.

It is according to another embodiment of the present invention wherein the film shape is polygonal, curved or a mixture thereof.

It is according to another embodiment of the present invention wherein the film shape is characterized in any pattern, e.g., humane shape, rod-like member, toothbrush shape.

It is according to another embodiment of the present invention wherein the print comprising data or information, being selected from any data, written text, drawings, pictures, cartoons, symbols, notes, musical notes, symbols, coded or indexed matter, numbers, video or musical trucks, valuables, money or money-worth articles, artistic matter or a combination thereof.

It is according to another embodiment of the present invention wherein the pattern or image is printed on the film by various printing technologies such as ink jet printing and stamping, while the ink components may react with the film components.

It is according to another embodiment of the present invention wherein the printed matter is either in gray scale or in full colors.

It is according to another embodiment of the present invention wherein the print is either permanent or is adapted to change its appearance in various environments.

It is according to another embodiment of the present invention wherein at least a portion of the print is provided as an indicator for the film's environment.

It is according to another embodiment of the present invention wherein a color is changed or developed at different environments or in presence of predetermine factors. It is according to another embodiment of the present invention wherein the film is either a continuous sheet or a porosive member.

It is according to another embodiment of the present invention wherein the film is at least partially transparent.

It is according to another embodiment of the present invention wherein the film is at least partially painted, tainted, colored or dyed.

It is according to another embodiment of the present invention wherein the print is provided in or upon the detergent film by methods selected from non-contact printing by ink injection devices; contact printing, e.g., tampon printing, by in-line or rotational printing machines or e.g., by silk/screen printing methods, attaching pre-printed decal or label on said film.

It is according to another embodiment of the present invention wherein the print is provided by reactive substances such as color or texture, e.g., by bleaching predetermined portions of the film by hypochlorite solutions, is provided or any combination thereof.

It is according to another embodiment of the present invention wherein the pigments, inks, inks jet inks are selected from artificial colorants, inks or dyes, and/or natural colorants, preferably edible colorants, and cosmetic grade colorants.

It is according to another embodiment of the present invention wherein the printing is performed while heating the film to a predetermined temperature, drying it and/or at least partially iron it.

It is another object of the present invention to disclose a stack of water-soluble detergent printed films comprising a plurality of said films being associated together.

It is another object of the present invention to disclose cleansing soap, shampoo, toothpaste soap, laundry detergent, dish-washer detergent, cosmetic, e.g., /or all purpose cleansing detergent, e.g., floor or vehicle detergent provided by the water-soluble detergent printed film as defined in any of the above.

It is another object of the present invention to disclose method of producing a water-soluble detergent printed film, comprising steps of forming a detergent film; and printing the same with at least one print.

It is lastly according to an embodiment of the present invention wherein the aforesaid method comprising steps selected from: (a) dissolving an effective measure of polysaccharides, proteins, or synthetic polymers in water; (b) admixing said solution with a soap at an adequate temperature; (c) pouring the solution into a flat casting container at a predetermined thickness; (d) drying the same such that a dry film is obtained; and, (e) peeling the film from said casting container, and printing a data onto it by means of an ink jet printer.

### BRIEF DESCRIPTION OF THE FIGURES

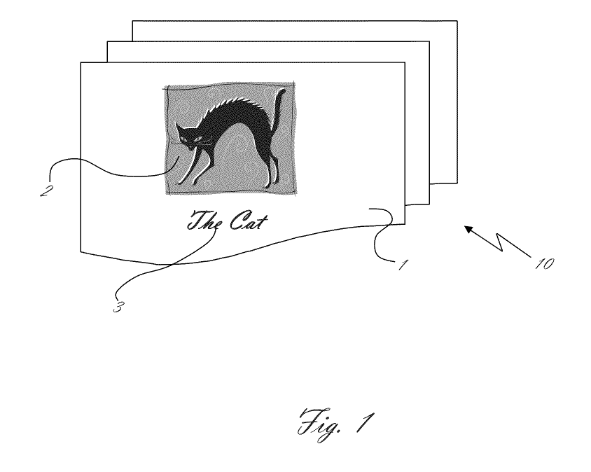

In order to understand the invention and to see how it may be implemented in practice, a preferred embodiment will now be described, by way of non-limiting example only, with reference to the accompanying drawing, in which FIG. 1 presenting schematic a stack comprising a plurality of water-soluble detergent printed films according to one embodiment of the present invention.

### DETAILED DESCRIPTION OF THE EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a water-soluble detergent printed film, a film stack and method of its production.

The term ‘polysaccharides’ refers hereinafter to any oligosaccharide or polysaccharide, glycosaminoglycans, and may be selected, at least partially, form alginates or pectates and similar carbohydrates. The term also denotes guar gums. Other natural polysaccharides which will form satisfactory films include gum Karaya, gum acacia, British gum, agar, starch, carib gum, gum Arabic, carrageenin and xanthan.

The natural polysaccharide film-forming ingredient includes natural polysaccharides and natural polysaccharide derivatives and may be a natural polyuronide film-forming material, for example, a pectin or an algin or mixtures of the same or may be a natural galactomannan film-forming material, for example, locust bean gum or guar gum.

Some of the natural polysaccharide film-forming materials which may be employed in the present wrapper composition are hydrolyzed guar gum, locust bean gum and, especially sodium alginate. The polysaccharide material, especially the pectinaceous material and/or guar gum, may be employed as the sole film-forming ingredient or may be combined with other film-forming ingredients (secondary film-forming agents) as defined below.

It is acknowledged in this respect that the polysaccharide film-forming material, and particularly the pectinaceous material or guar gum, may be used alone or it may be used in combination with an equal amount or less of a second film-forming ingredient. Said second film-forming ingredient is selected in a non-limiting manner from a natural polysaccharide, such as locust bean gum or certain alginates.

The term ‘polysaccharide’ also refers to either synthetic ort natural polyuronides, wherein natural polyuronide are film-forming materials, including the pectins and algins, and the natural galactomannan film-forming materials, including locust bean gum and guar gum.

The term ‘pectin’ refers hereinafter to fruit or vegetable pectin, pectin derivatives, methylated pectin, pectin salts, at least partially hydrolyzed or other wised reacted pectin, commercial pectin extracted from said origin or a pectin-containing plant component or to any combination thereof.

It is in the scope of the present invention and in a non-limiting manner, cellulose derivatives are also used as film formers.

The term ‘protein’ especially refers to gelatin, whey proteins or any other soluble polymeric compositions.

Synthetic polymers such as polyvynilpirrolidone (PVP) and polyvinyl alcohol (PVA) can also be used as film formers, alone or in combination with other film forming molecules.

The term ‘additives’ refers hereinafter to plasticizers, filers, biocides, preservatives, vitamins, enzymes, nutrichemicals, buffers coloring agents, perfume agents, surface active agents, emulsifiers, co-emulsifiers, stabilizers, pigments such as titanium oxide, liquid detergents, salts, flavors or flavorants, cross-linking agents nutrients, aromatic substances, fibers, yarns, plant extracts, fruits or vegetables and whole parts of milled particles thereof, humectants, bleaching agents or any combination thereof.

The term ‘plasticizer’ refers hereinafter to molecules imparting plasticizing effect to the film.

The term ‘humectants’ refers hereinafter to compositions selected in a non limiting manner from glycerine, monoacetyl glycerol, triethylene glycol, invert sugar, corn syrup etc.

The term ‘film’ generally refers henceforth to at least partially water-soluble films characterized by a requisite tensile strength and elasticity. The film-shaped sheet or any other leaf-like member can be plane (e.g., 2D shaped), wave-shaped or otherwise 3D shaped member, slit to tape and used as a wrapper or any combination thereof. The film may be further selected from at least partially water-immiscible films, or diluent-miscible films, or disassembled films or any combination of the same.

It is in the scope of the present invention wherein water-soluble detergent printed film is presented. The films will generally be about 0.2 to about 2.5 mm thick. The length and high dimensions of the films are preferably yet not exclusively from about 0.5*0.5 cm or less to about 50*50 cm or more (i.e., true dimensions, measured by avoiding irregularities). The shape of the film may be polygonal, curved or a mixture thereof, and may comprise any pattern, e.g., humane shape, rod-like member, toothbrush shape etc.

The term ‘print’ refers hereinafter to any data or information, wherein the data is selected in a non-limiting manner from any data, written text, images drawings, pictures, cartoons, symbols, notes, musical notes, symbols, coded or indexed matter, numbers, or a combination thereof.

The print is either in gray scales or in full colors, wherein said color is either permanent or change its appearance in various environments. Hence, the film may be transparent before utilized, in its dry form, and colorful when washed by water, and vice versa. It is in the scope of the present invention that said color or print is provided as an indicator for the environment. For example, different color is provided at different environment or in presence of predetermine factors,

It is further in the scope of the present invention wherein said printed detergent is having various advantages and distinctive features: It has a novel appearance and can, if desired, be transparent. The printed matter is possibly made in a predetermined manner non-porous or with varying degrees of porosity.

The printing in or upon said water soluble detergent film is provided by various methods known in the art, selected in a non-limiting manner from non-contact printing by ink injection devices; contact printing, e.g., tampon printing, by in-line or rotational printing machines or e.g., by silk/screen printing methods, attaching pre-printed decal or label on said film. Moreover, the printing may be provided by coating or by reacting at least a portion of the surface of the film with a reactive substances such as color or texture, e.g., by bleaching predetermined portions of the film by hypochlorite solutions, is provided or any combination thereof. Said printed matter by alternatively or additionally coated with at least one protecting layers, adapted to stabilize said data and to maintain the printed data. Said inks which contain pigments or dyes are selected in a non-limiting manner from artificial colorants and natural colorants, so as said natural colorants may be selected from edible colorants, food-grade colorants etc. Other possibility of printing the detergent film is achieved while heating it to a predetermined temperature, drying and/or at least partially iron it.

### Example 1

A preferred example of a method in accordance with the present invention of making a substantially water-soluble detergent film is achieved by: (i) dissolving sodium alginate (3%) in water, mixing it with a commercial liquid soap (1:1 volume ratio), all performed at 60° C.; (ii) pouring the solution into a flat casting container at a thickness of 0.5 mm; (iii) drying said liquid at 80° C. until a dry film is obtained. The film is then peeled from the casting container, and an image is printed onto it by using an ink jet printer (e.g., the ink is solvent based).

### Example 2

As example 1, while the polymer is polyvinylpirrolidone.

### Example 3

As example 1, while the polymer is gum Arabic.

### Example 4

As example 1, while the polymer is gelatin, starting solution contains about 5 to 20% gelatin and about 2 to 10% glycerol.

### Example 5

As example 1, while the liquid soap is replaced by a solution of sodium dodecyl sulphate.

### Example 6

As example 1, while the printing on the film is conducted by a commercial office ink jet printer, namely commercially available HP 5150™, which uses water-based ink.

### Example 7

As example 1, while the writing on the film is performed by using a cosmetic colorant dissolved in water.

1. An article of manufacture comprising a water-soluble detergent printed film as comprising:
a. a water-dissolvable film support, comprising;
i. at least one polymer; and,
ii. soap, the volume ratio of said soap to said polymer ranges from about 0.5 to about 2.0, especially about 1 to about 1;
b. at least one print, being ink-jet printed thereon and/or therein said film support;
said thin films are stable substrates for ink-jet printing, such that stability is maintained for both (i) said printed film support; and (ii) said print.
wherein said article of manufacture is selected from a group consisting of: a stack of water-soluble detergent printed, comprising a plurality of said films being associated together; a cleansing soap; a shampoo; a toothpaste soap; a laundry detergent; a dish-washer detergent; an all purpose cleansing detergent, especially floor or vehicle detergent.

2. The article of manufacture according to claim 1, wherein the film support is at least partially made of polysaccharides, proteins, or synthetic polymers and any combination thereof; especially wherein said polysaccharides are selected from a group consisting of oligosaccharide, polysaccharide, glycosaminoglycans, polyuronides, guar gum, gum Karaya, gum acacia, British gum, agar, starch, carrageenan and xanthan, Gum Arabic, sodium alginate and any combination thereof; said polyuronides are selected from a group consisting of pectins, algins, natural galactomannan film-forming materials, especially locust bean gum and guar gum and any combination thereof.

3. The article of manufacture according to claim 1, additionally comprising secondary film-forming agents, especially wherein said film-forming agents are selected from a group consisting of polysaccharides, salts, polymers, pulps, pectin, fibers, yarns, cellulose, glycolic acid and any combination thereof.

4. The article of manufacture according to claim 1, additionally comprising additives, selected from a group consisting of plasticizers, fillers, biocides, preservatives, elastomers, vitamins, enzymes, nutrichemicals, buffers, coloring agents, perfume agents, surface active agents, emulsifiers, co-emulsifiers, stabilizers, pigments such as titanium oxide, liquid detergents, salts, flavors or flavorants, nutrients, aromatic substances, fibers, yarns, silica, plant extracts, humectants, bleaching agents and any combination thereof.

5. The article of manufacture according to claim 1, wherein the film is at least partially either (i) water-soluble support, characterized by a requisite tensile strength and elasticity, or (ii) water-dissolvable.

6. The article of manufacture according to claim 1, wherein the film is shaped in a manner selected from a group consisting of leaf-like member, a plane sheet, wave-shaped or otherwise 3D shaped member, slit to tape and used as a wrapper, human shapes, rod-like members, toothbrush shapes and any combination thereof; and further wherein said film shape is polygonal, curved or a combination thereof.

7. The article of manufacture according to claim 1, wherein the dimensions of the film are 0.2 to about 2.5 mm thick; and from about 5*5 mm to about 500*500 mm in length and height.

8. The article of manufacture according to claim 1, wherein said print is selected from a group consisting of data, written text, drawings, pictures, cartoons, symbols, notes, musical notes, symbols, coded or indexed matter, numbers, or images; and further wherein said data is printed, written, coated, bleached, reacted in any manner on, or in the film substrate, or in, or on a plurality of film substrates; said print is especially provided either (i) in gray scale or (ii) in true (full) colors.

9. The article of manufacture according to claim 8, wherein the print is either permanent or is adapted to change its appearance in various environments; and especially wherein at least a portion of said print is an indicator of said environment.

10. The article of manufacture according to claim 1, wherein at least one of the following holds true:
a. the film is either a continuous sheet or a porosive member;
b. film is at least partially transparent; and,
c. the film is at least partially painted, tainted, dyed or otherwise colored.

11. The article of manufacture to claim 1, wherein the print is provided in or upon the detergent film by methods selected from non-contact printing by ink injection devices; contact printing, especially tampon printing, by in-line or rotational printing machines or especially by silk/screen printing methods, attaching pre-printed decal or label on said film; especially wherein said print is provided by bleaching predetermined portions of the film by hypochlorite solutions; and especially wherein said printing is provided by heating the film to a predetermined temperature, drying it and/or at least partially ironing it.

12. The article of manufacture according to claim 1, wherein the inks are selected from artificial colorants, pigments or dyes, and/or natural colorants, preferably edible colorants, and food-grade colorants.
